(19) United States
(12) Patent Application Publication
(10) Pub. No.: US 2010/0149359 A1
(43) Pub. Date: Jun. 17, 2010

(54) IMAGING APPARATUS, IMAGING METHOD, AND PROGRAM FOR EXECUTING THE IMAGING METHOD

(75) Inventor: Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/351,086

(22) Filed: Jan. 9, 2009

(30) Foreign Application Priority Data
Dec. 17, 2008 (KR) 10-2008-0128651

(51) Int. Cl. H04N 5/228

(52) U.S. Cl. 348/222.1

(57) ABSTRACT

Provided is an imaging apparatus, method, and a program on a media, which accurately determine a subject while photographing the subject by rotating an imaging surface. The apparatus displays a photographed image of the subject formed on an image pickup device surface on a display unit screen. It includes an angle detector, which detects angle information for the imaging surface of the image pickup device tilted with respect to a gravitational horizontal standard, based on a reference point on a plane having a photographing direction of the subject as a normal, within in a body of the imaging apparatus during photographing; and a display controller, which generates an index mark by rotating the photographed image by the angle based on the reference point according to the detected angle information, and displays the index mark by overlapping the index mark on the photographed image of the display screen.

### CROSS-REFERENCE TO RELATED PATENT APPLICATION

This application claims the benefit of Korean Patent Application No. 10-2008-0128651, filed on Dec. 17, 2008, in the Korean Intellectual Property Office, the disclosure of which is incorporated herein in its entirety by reference.

### BACKGROUND

1. Field of the Invention

The present invention relates to an imaging apparatus, an imaging method, and a program for executing the imaging method.

2. Description of the Related Art

In an imaging apparatus, such as a camera, a subject may be photographed by tilting or perpendicularly placing the imaging apparatus. In other words, a moving image may be recorded by photographing the subject while changing a photographing angle. Here, when the moving image with the changed photographing angle is reproduced on an apparatus for displaying an image, such as a television or a monitor, the subject is displayed while being tilted with respect to a horizontal direction, and thus it is inconvenient to view the moving image.

As such, when an angle of the imaging apparatus is changed while shooting the moving image, a technology of detecting the angle, recording angle information about the angle and the subject, and reproducing the moving image by rotating the moving image by using a linear transformation according to the angle information, is used. For example, Japanese Patent Laid-open Publication No. 2006-211378 discloses a technology of recording angle information and reproducing a tilted image by cutting the maximum tetragon from the tilted image according to the angle information.

However, when the entire moving image with the changed angle is to be displayed on a television or a monitor, a display ratio of the image must be reduced below 1× magnification. Generally in the imaging apparatus, the number of horizontal pixels is bigger than the number of vertical pixels. Accordingly, when an image is vertically photographed, the photographed image needs to be reduced to (number of vertical pixels/number of horizontal pixels)×magnification, in order to display the entire photographed image on a television or a monitor. As a result, an image that is different from a photographer's intention may be displayed.

Meanwhile, a center portion of the moving image with a changed angle may be extracted in a tetragon, and the extracted center portion may be displayed on a television or a monitor. Here, portions other than the extracted center portion are not displayed. Accordingly, an important subject may not be displayed on the television or the monitor.

### SUMMARY

The present invention provides an imaging apparatus, an imaging method, and a program for executing the imaging method, which accurately determines a subject while photographing the subject by rotating an imaging surface.

According to an aspect of the present invention, there is provided an imaging apparatus, which displays a photographed image of a subject formed on an imaging surface of an image pickup device on a display screen of a display unit, the imaging apparatus including: an angle detector, which detects angle information about an angle of the imaging surface of the image pickup device tilted with respect to a horizontal standard that is perpendicular to a gravity direction, based on a reference point on a plane having a photographing direction of the subject as a normal, in a holding location of a body of the imaging apparatus during photographing; and a display controller, which generates an index mark by rotating the photographed image by the angle based on the reference point according to the angle information detected by the angle detector, and displays the index mark by overlapping the index mark on the photographed image of the display screen of the display unit.

Accordingly, the index mark that is rotated by the tilted angle detected by the angle detector is displayed on the display screen of the display unit by being overlapped with the image of the subject. By imaging the subject according to the index mark, a photographer accurately captures the subject.

The display controller may determine a size of the index mark according to an aspect ratio of the display screen of the display unit.

The imaging apparatus may further include: a memory, which stores the angle information by corresponding the angle information with the photographed image in a frame unit; and an image converter, which converts an image area provided by the index mark in the photographed image to a horizontal standard image by rotating the image area by the angle, according to the image of the subject and corresponding angle information read from the memory.

According to another aspect of the present invention, there is provided an imaging method for displaying a photographed image of a subject formed on an imaging surface of an image pickup device on a display screen of a display unit, the imaging method including: detecting angle information about an angle of the imaging surface of the image pickup device tilted with respect to a horizontal standard that is perpendicular to a gravity direction, based on a reference point on a plane having a photographing direction of the subject as a normal, in a holding location of a body of an imaging apparatus during photographing; and generating an index mark by rotating the photographed image by the angle based on the reference point according to the angle information, and displaying the index mark by overlapping the index mark on the photographed image of the display screen of the display unit.

A size of the index mark may be determined according to an aspect ratio of the display screen of the display unit.

The imaging method may further include: storing the angle information by corresponding the angle information with the photographed image in a frame unit; and converting an image area provided by the index mark in the photographed image to a horizontal standard image by rotating the image area by the angle, according to the image of the subject and corresponding angle information read from the memory.

According to another aspect of the present invention, there is provided a program for executing an imaging method in a computer, the imaging method including: detecting angle information about an angle of an imaging surface of an image pickup device tilted with respect to a horizontal standard that is perpendicular to a gravity direction, based on a reference point on a plane having a photographing direction of a subject as a normal, in a holding location of a body of an imaging apparatus during photographing; generating an index mark by rotating a photographed image of the subject by the angle based on the reference point according to the angle information, and displaying the index mark by overlapping the index mark on the photographed image of a display screen of a display unit; storing the angle information by corresponding the angle information with the photographed image in a frame unit; and converting an image area provided by the index mark in the photographed image to a horizontal standard image by rotating the image area by the angle, according to the image of the subject and corresponding angle information read from the memory.

A size of the index mark may be determined according to an aspect ratio of the display screen of the display unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an imaging apparatus according to an embodiment of the present invention;

FIG. 2 is a block diagram illustrating a reproducing apparatus according to an embodiment of the present invention;

FIG. 3 is a pictorial diagram for describing a portrayal example of boundary lines of an index mark in a display unit, according to an embodiment of the present invention;

FIG. 4 is a pictorial diagram for describing a screen of a display unit of an imaging apparatus, according to an embodiment of the present invention;

FIGS. 5(a) and (b) are pictorial diagrams for respectively describing a screen of a display unit of an imaging apparatus and a screen of a display device, according to an embodiment of the present invention; and

FIGS. 6(a) and (b) are pictorial diagrams for respectively describing a screen of a display unit of an imaging apparatus and a screen of a display device, according to another embodiment of the present invention.

### DETAILED DESCRIPTION OF THE PREFERRED EMBODIMENTS

Hereinafter, the present invention will be described more fully with reference to the accompanying drawings, in which exemplary embodiments of the invention are shown. In the drawings, like reference numerals denote like elements.

Structures of an imaging apparatus 100 and a reproducing apparatus 200 according to embodiments of the present invention will now be described. The imaging apparatus 100 and the reproducing apparatus 200 are separately formed as independent apparatuses, but the imaging apparatus 100 and the reproducing apparatus 200 may be integrally formed.

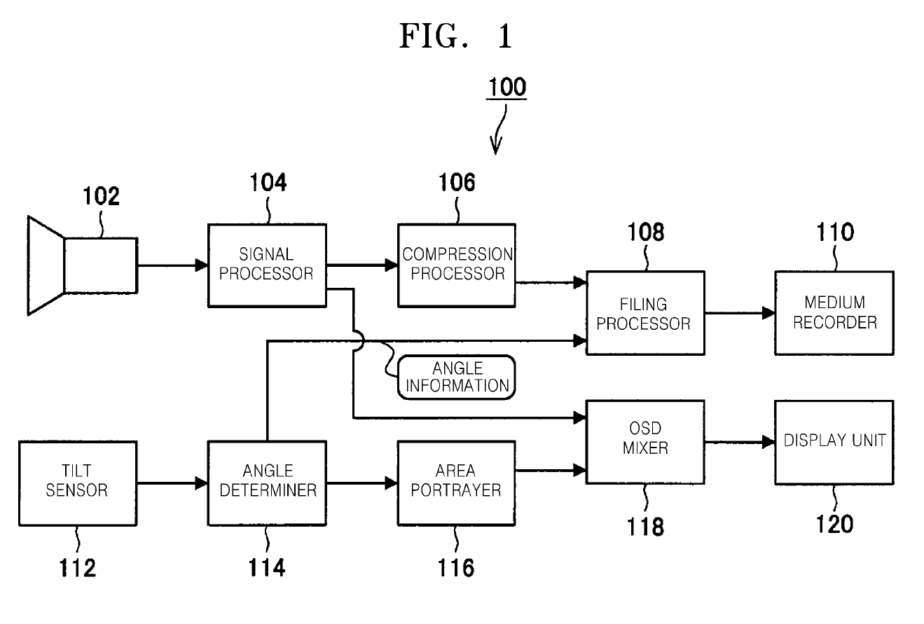

The imaging apparatus 100 according to an embodiment of the present invention will be described with reference to FIG. 1. FIG. 1 is a block diagram illustrating the imaging apparatus 100 according to the current embodiment of the present invention.

Examples of the imaging apparatus 100 include a camera and a camcorder which can photograph and record a subject in a moving image. The imaging apparatus 100 may include an optical system 102, a signal processor 104, a compression processor 106, a filing processor 108, a medium recorder 110, a tilt sensor 112, an angle determiner 114, an area portrayer 116, an on-screen display (OSD) mixer 118, and a display unit 120.

The optical system 102 may include a focus lens, a zoom lens, an iris, a driver, and an image pickup device. The optical system 102 forms an image of a subject on the image pickup device by penetrating light from the subject. The focus lens is adjusted so as to focus the subject on the image pickup device. The zoom lens is adjusted to change a focus distance. The iris is adjusted to change intensity of light incident on the image pickup device. Also, the driver drives the focus lens, the zoom lens, and the iris. The driver drives each element according to a focus control and exposure control of a central processing unit (CPU).

The image pickup device is an image sensor, such as a charge coupled device (CCD) or a complementary metal oxide semiconductor (CMOS), and outputs optical information formed on the image pickup device to the signal processor 104 by converting the optical information to an electric signal (image signal) by photoelectric conversion. The image pickup device outputs an electric signal at every single frame.

The signal processor 104 is formed of circuits, such as a correlated double sampling (CDS) circuit, an amp circuit, and an analog/digital (A/D) conversion circuit. The CDS circuit removes noise from the electric signal output from the image pickup device, and the amp circuit amplifies the electric signal. The A/D conversion circuit digitalizes electric signals sequentially output in a frame unit. The signal processor 104 sequentially transmits image data obtained via digital conversion to the compression processor 106 and the OSD mixer 118 in a frame unit.

The compression processor 106 compresses the image data output from the signal processor 104. The compression processor 106 may compress the image data via MPEG-4.

The filing processor 108 generates a data file, which includes the image data output from the compression processor 106 and angle information output from the angle determiner 114. The filing processor 108 encodes the angle information by corresponding the angle information with the image data in a frame unit. The filing processor 108 outputs the generated data file to the medium recorder 110. When the data file is reproduced in the reproducing apparatus 200, an image is displayed while being rotated at a time that the image apparatus 100 is rotated during photographing, by storing the angle information in the data file by corresponding the angle information with the image data in a frame unit.

The medium recorder 110 stores the angle information by corresponding the angle information with the image data in a frame unit. The medium recorder 110 is an example of a memory, and controls writing of the data file in a recording medium, or reading of the data file or setting information recorded in the recording medium. Examples of the recording medium include an optical recording medium (CD or DVD), a magneto-optical disc, a magnetic disc, and a semiconductor recording medium. The recording medium records the data file generated in the filing processor 108. The medium recorder 110 may be detachable from the imaging apparatus 100.

The tilt sensor 112 may be an angle sensor, and is installed inside the imaging apparatus 100. The tilt sensor 112 detects tilting of the imaging apparatus 100, and transmits the detected tilt to the angle determiner 114.

The angle determiner 114 calculates an angle of an imaging surface of the imaging pickup device on which the subject is formed, according to the tilt detected by the tilt sensor 112. Here, the angle is an angle of the imaging surface of the image pickup device tilted with respect to a horizontal standard that is perpendicular to a gravity direction, based on a reference point on a plane having a photographing direction of the subject as a normal, in a location that a user normally holds a body of the imaging apparatus during photographing. The calculated angle is transmitted to the filing processor 108 and the area portrayer 116 as angle information. A unit including the tilt sensor 112 and the angle determiner 114 may be an angle detector.

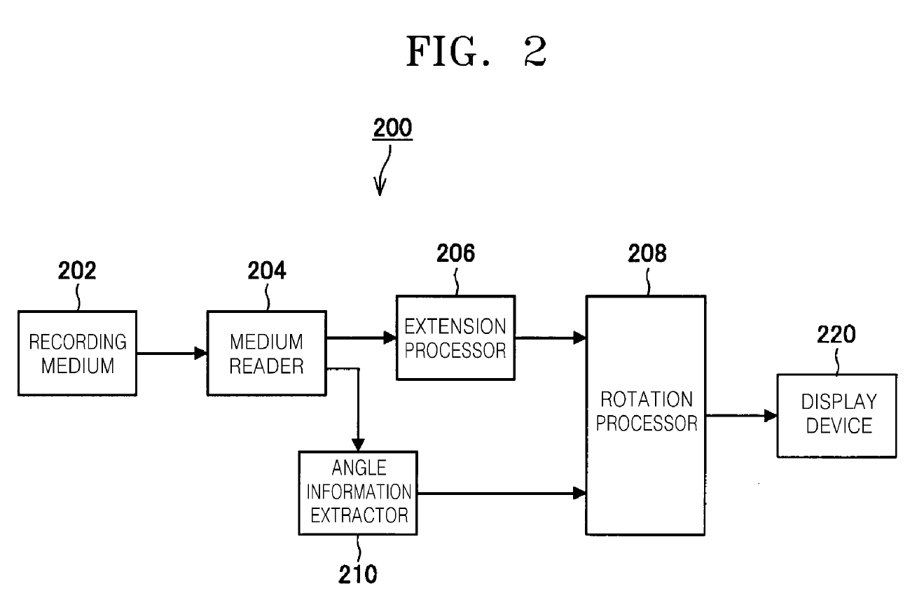

The area portrayer 116 calculates boundary lines 132, 134, 136, and 138 of an index mark in order to simultaneously display the index mark while displaying the image of the subject on the display unit 120. The index mark is an area of an image wherein the image of the subject is rotated by the angle based on the reference point, according to the angle information of the tilt sensor 112 and the angle determiner 114, and is an area that can photograph the subject without changing resolution of a display device 220 of FIG. 2, like the subject is photographed when the imaging apparatus 100 is in a horizontal state, even when the imaging apparatus 100 is tilted. A size of the index mark may be determined according to an aspect ratio of the display screen of the display unit 120. When an important subject is photographed within the index mark, and a moving image is reproduced according to angle information recorded during photographing, the important subject may be displayed as intended during the photographing. The area portrayer 116 rotates the image on the imaging surface of the image pickup device by the angle calculated in the angle determiner 114.

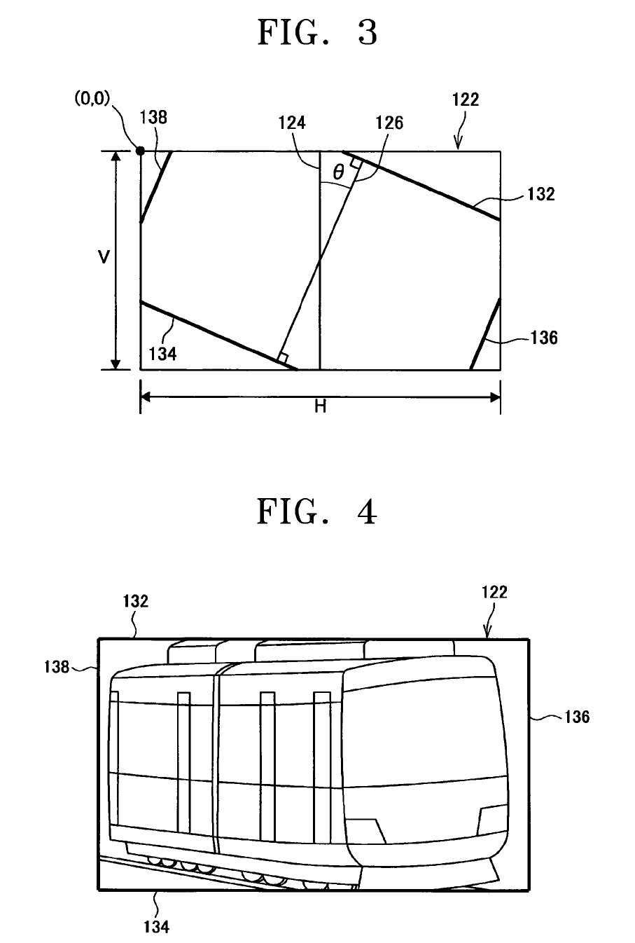

A portrayal example of the boundary lines 132, 134, 136, and 138 of the index mark will now be described with reference to FIG. 3. FIG. 3 is a diagram for describing the portrayal example of the boundary lines 132, 134, 136, and 138 of the index mark in the display unit 120, according to an embodiment of the present invention;

When the imaging apparatus 100 has a tilt angle θ, the boundary lines 132, 134, 136, and 138 are portrayed on a screen 122 of the display unit 120 as illustrated in FIG. 3. An area surrounded by the boundary lines 132, 134, 136, and 138 is an area indicating the index mark. An angle θ denotes an angle between a perpendicular line 124 of the screen 122 and a perpendicular line 126 of the area indicating the index mark.

When a number of horizontal pixels of the screen 122 is H and a number of vertical pixels of the screen 122 is V, the boundary lines 136 and 138 are portrayed while a distance between the boundary line 136 and the boundary line 138 maintains the number of horizontal pixels H, and the boundary lines 132 and 134 are portrayed while a distance between the boundary line 132 and the boundary line 134 maintains the number of vertical pixels V. Also, when the upper left screen 122 is (x,y)=(0,0), a downward direction of the screen 122 is an +x axis, and a right side of the screen 122 is a +y direction, the boundary lines 132, 134, 136, and 138 are expressed as Equation 1 below.

$$Boundary Line 132 \text{:} \\ y = x tan θ - \frac{H}{2} tan θ - \frac{\frac{V}{2}}{cos θ} \\ Boundary Line 134 \text{:} \\ y = x tan θ - \frac{H}{2} tan θ + \frac{\frac{V}{2}}{cos θ} \\ Boundary Line 136 \text{:} \\ y = - \frac{x}{tan θ} + \frac{\frac{H}{2}}{tan θ} + \frac{\frac{H}{2}}{sin θ} \\ Boundary Line 138 \text{:} \\ y = - \frac{x}{tan θ} + \frac{\frac{H}{2}}{tan θ} - \frac{\frac{H}{2}}{sin θ} \qquad Equation 1$$

As such, when the boundary lines 132, 134, 136, and 138 are displayed and an image is photographed within the index mark surrounded by the boundary lines 132, 134, 136, and 138, the subject is recorded without changing resolution of the image.

The OSD mixer 118 mixes the image data output from the signal processor 104 and the index mark calculated in the area portrayer 116, and generates data for overlapping and displaying the image and the index mark on the display unit 120.

The display unit 120 may include a liquid crystal display (LCD) or an electric view finder (EVF). The display unit 120 displays a live-view image, various setting screens of the imaging apparatus 100, or a photographed image. The display unit 120 includes a display controller, and is driven by the display controller. The display controller controls the display unit 120 so that the index mark is overlapped on the image on the display screen of the display unit 120. The display controller may be included in the imaging apparatus 100, and the display unit 120 may be separately formed from the imaging apparatus 100.

Each element of the imaging apparatus 100 is controlled by the CPU. The CPU may work as a processing apparatus and a controlling apparatus according to a program recorded in a memory, and may control processes of elements installed in the imaging apparatus 100. The CPU drives the optical system 102 by outputting a signal to a driver according to a focus control or an exposure control. Also, the CPU controls each element of the imaging apparatus 100 according to a signal from a manipulator. In the current embodiment, a single CPU is used, but a plurality of CPUs may also be used, where the CPUs each perform a command from a signal system and a command from a manipulation system. The manipulator includes a power switch, a recording start button, etc., and is used by a user to perform operations and various settings of the imaging apparatus 100. The recording start button is a button for manipulating photographing.

The structure of the reproducing apparatus 200 according to an embodiment of the present invention will now be described with reference to FIG. 2. FIG. 2 is a block diagram illustrating the reproducing apparatus 200 according to the current embodiment of the present invention.

The reproducing apparatus 200 reproduces image data according to the data file recorded in the imaging apparatus 100 according to the previous embodiment of the present invention. The reproducing apparatus 200 may include a medium reader 204, an extension processor 206, a rotation processor 208, and an angle information extractor 210.

The medium reader 204 reads image data or setting information recorded in a recording medium 202. Examples of the recording medium 202 include an optical recording medium (CD or DVD), a magneto-optical disc, a magnetic disc, and a semiconductor recording medium, and the recording medium 202 records the image data as a data file. The recording medium 202 and the medium reader 204 may be detachable from the reproducing apparatus 200. When the data file generated in the imaging apparatus 100 is recorded in the recording medium 202, the data file is read by the medium reader 204. The medium reader 204 transmits the data file to the extension processor 206 and the angle information extractor 210.

The extension processor 206 obtains compressed image data output from the medium reader 204. When image data is compressed in a MPEG-4 form by the compression processor 106 of the imaging apparatus 100, the extension processor 206 extends the compressed image data. The extension processor 206 transmits the extended image data to the rotation processor 208.

The rotation processor 208 obtains the image data output from the extension processor 206 and the angle information output from the angle information extractor 210. The rotation processor 208 is an example of an image converter, and converts an image area provided by the index mark to a horizontal standard image by rotating the image area by the angle detected by the tilt sensor 112 and the angle determiner 114, according to the image data and corresponding angle information read from the recording medium 202. For example, when image data and angle information are correspondingly recorded in each frame, the rotation processor 208 rotates an image corresponding to image data of a corresponding frame according to angle information of the corresponding frame. The rotation processor 208 transmits the rotated image data to the display device 220. The rotation processor 208 rotates the image of the subject on the imaging surface that corresponds to a display area according to the image of the subject recorded at every frame and angle information recorded correspondingly to the frame, thereby suitably adjusting at least a part of an outline of the display area and a display frame of the display device 220. The rotation processor 208 prepares the image data as the horizontal standard image, and reproduces an image recorded in the image apparatus 100 in the display device 220 of a wide use.

The rotation processor 208 may perform a conventional image process. Examples of an image process include white balance control and exposure control of the image data. The rotation processor 208 performs YC conversion process on the image data, and converts the image data into a luminance signal and a chrominance signal. The rotation processor 208 converts the luminance signal and the chrominance signal into an analog signal, and transmits the analog signal to the display device 220.

The angle information extractor 210 obtains the data file output from the medium reader 204, and extracts angle information from the obtained data file. The angle information extractor 210 transmits the extracted angle information to the rotation processor 208.

The display device 220 includes a display means, such as a television or a monitor including an LCD. The display device 220 may display various setting screens of the reproducing apparatus 200 or an image read from the recording medium and output from the rotation processor 208. The display device 220 may be connected to the reproducing apparatus 200 via a high definition multimedia interface (HDMI) or a D terminal.

Each element of the reproducing apparatus 200 according to the current embodiment of the present invention is controlled by a CPU. The CPU may work as a processing apparatus and controlling apparatus according to a program, and controls each element installed in the reproducing apparatus 200. The CPU may drive the medium reader 204 by outputting a signal to the medium reader 204 according to manipulation of a manipulator. Also, the CPU controls each element of the reproducing apparatus 200 according to a signal from the manipulator. In the current embodiment, a single CPU is used, but a plurality of CPUs may also be used, where CPUs each perform a command from a signal system and a command from a manipulation system. The manipulator includes a power switch, a reproduction operating button, and various setting keys, and is used by a user to perform operations and various settings of the reproducing apparatus 200.

Operations of the imaging apparatus 100 and the reproducing apparatus 200 will now be described with reference to FIGS. 1 and 2.

First, an imaging process in the imaging apparatus 100 will be described with reference to FIG. 1. When photographing starts, the subject forms an image on the optical system 102 and simultaneously the tilt sensor 112 detects a tilt of the imaging surface.

The electric signal output from the optical system 102 is converted to the image data in the signal processor 104, and the image data is transmitted to the compression processor 106 and the OSD mixer 118. The image data is compressed in the compression processor 106, and the compressed image data is transmitted to the filing processor 108.

Meanwhile, the angle determiner 114 calculates an angle of a rotated imaging surface from the tilt detected by the tilt sensor 112, and the calculated angle is transmitted to the filing processor 108 and the area portrayer 116 as the angle information.

The filing processor 108 may generate the data file by corresponding the obtained image data and the angle information in a frame unit. The filing processor 108 transmits the generated data file in the medium recorder 110, and the medium recorder 110 records the data file in the recording medium.

The area portrayer 116 calculates the index mark according to the obtained angle information, and transmits data about the calculated index mark to the OSD mixer 118. The OSD mixer 118 overlaps the obtained image data and the data about the calculated index mark, and transmits the overlapped data to the display unit 120. The display unit 120 displays the subject photographed in the optical system 102 and the index mark according to the angle of rotating the imaging apparatus 100.

Next, a reproducing process of the reproducing apparatus 200 will now be described with reference to FIG. 2.

The recording medium 202 records the data file including the image data and the angle information recoded in the imaging apparatus 100. The medium reader 204 reads the data file from the recording medium 202. The read data file is transmitted to the extension processor 206 and the angle information extractor 210.

The extension processor 206 extracts the image data from the data file, and extends the compressed image data. The extended image data is transmitted to the rotation processor 208. Meanwhile, the angle information extractor 210 extracts the angle information from the data file. The extracted angle information is transmitted to the rotation processor 208.

The rotation processor 208 obtains the image data and the angle information, and rotates the image data at each frame according to the angle information. The rotated image data is transmitted to the display device 220. Here, a display frame of the display device 220 may be suitably adjusted to at least a part of a boundary line of a display area of the imaging apparatus 100.

Since the angle information and the image data are correspondingly recorded in the imaging apparatus 100, the image data is displayed after being rotated according to the angle information when the reproducing apparatus 200 reads the data file and rotates the image data. Accordingly even when the subject is recorded by rotating the imaging apparatus 100, the subject is displayed on the display device 220 while maintaining a horizontal state.

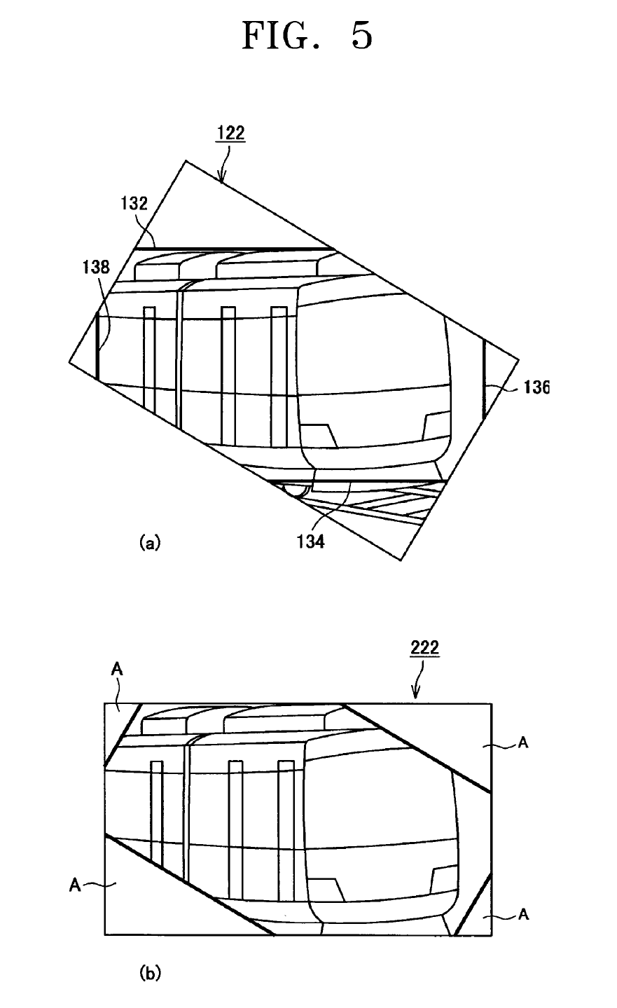

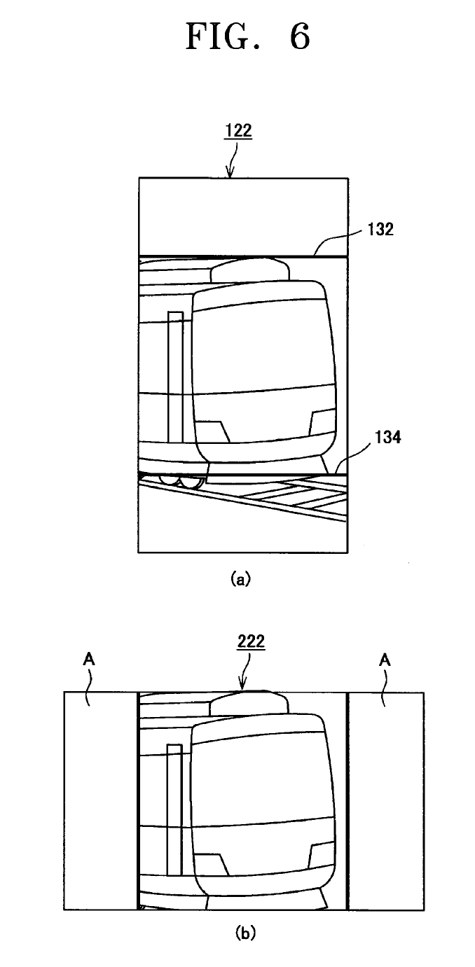

Next, an example of displaying the image data and the display area on the screen 122 of the display unit 120, and an example of displaying an image recorded in the image apparatus 100 on the display device 220 will be described with reference to FIGS. 4, 5, and 6. FIG. 4 is a diagram for describing the screen 122 of the display unit 120 of the imaging apparatus 100, according to an embodiment of the present invention. FIGS. 5(a) and (b) and FIGS. 6(a) and (b) are diagrams for respectively describing the screen 122 of the display unit 120 of the imaging apparatus 100 and a screen 222 of the display device 220, according to embodiments of the present invention.

When the subject is photographed while horizontally holding the imaging apparatus 100, the subject is displayed on the screen 122 of the display unit 120 of the imaging apparatus 100 as illustrated in FIG. 4. In other words, the boundary lines 132, 134, 136, and 138 indicating a display area are displayed along a frame of the screen 122. Alternatively, since the boundary lines 132, 134, 136, and 138 correspond with the frame of the screen 122, the boundary lines 132, 134,136, and 138 may not need to be displayed.

When the subject is photographed while tilting the imaging apparatus 100 in a certain angle, the subject is displayed on the screen 122 of the display unit 120 of the imaging apparatus 100 as illustrated in FIG. 5(a). In other words, the screen 122 is tilted in the certain angle, but the index mark displays a displayable area while maintaining resolution and display magnification by the boundary lines 132, 134, 136, and 138. As a result, a photographer may be led to photograph an important subject to be included in the index mark.

When the imaging apparatus 100 is tilted in a certain angle and image data is recorded with angle information, a moving image is displayed on the display device 220 as illustrated in FIG. 5(b) when the image data is reproduced in the reproducing apparatus 200. A subject that is outside the index mark displayed on the display unit 120 of the imaging apparatus 100 is also outside the frame of the display device 220, but when an important subject is photographed within the index mark, the important subject is displayed with the same resolution and magnification as photographed while holding the imaging apparatus 100 in a horizontal state. Areas A of FIG. 5(b) which are areas that are not photographed by the imaging apparatus 100 may be processed by the reproducing apparatus 200 so as to be displayed transparently or in a predetermined fixed color. Alternatively, the areas A may be composed with another image.

Also, when the subject is photographed while perpendicularly holding the imaging apparatus 100, the subject is displayed on the screen 122 of the display unit 120 of the imaging apparatus 100 as illustrated in FIG. 6(a). In other words, the screen 122 may be perpendicular, but the index mark displays a displayable area by the boundary lines 132 and 134 while maintaining resolution and magnification. As a result, a photographer may be led to photograph the subject within the index mark.

When the imaging apparatus 100 is perpendicularly held and image data is recorded with angle information, a moving image is displayed on the display device 220 as illustrated in FIG. 6(b) when the image data is reproduced in the reproducing apparatus 200. A subject outside the index mark displayed on the display unit 120 of the imaging apparatus 100 is also outside the display device 220, but when an important subject is photographed within the index mark, the important subject is displayed with the same magnification and resolution as photographed while horizontally holding the imaging apparatus 100. Areas A of FIG. 6(b) which are areas that are not photographed by the imaging apparatus 100 may be processed by the reproducing apparatus 200 so as to be displayed transparently or in a predetermined fixed color. Alternatively, the areas A may be composed with another image.

In the above embodiments, a display area is displayed while maintaining resolution and display magnification as in a horizontal state, but the present invention is not limited thereto. For example, the display area may be displayed on the display unit 120 of the imaging apparatus 100 by changing the display magnification but maintaining the horizontal state.

Accordingly, the subject is accurately determined when the imaging surface is rotated during photographing.

The imaging method may be provided as a computer executable program. Codes and segments forming the program may be easily construed by programmers skilled in the art to which the present invention pertains.

Any software modules that are implemented may be stored as program instructions or computer readable codes executable on the processor on a computer-readable media such as read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. This media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. An imaging apparatus, which displays a photographed image of a subject formed on an imaging surface of an image pickup device on a display screen of a display unit, the imaging apparatus comprising:
an angle detector, which detects angle information about an angle of the imaging surface of the image pickup device tilted with respect to a horizontal standard that is perpendicular to a gravity direction, based on a reference point on a plane having a photographing direction of the subject as a normal, in a holding location of a body of the imaging apparatus during photographing; and
a display controller, which generates an index mark by rotating the photographed image by the angle based on the reference point according to the angle information detected by the angle detector, and displays the index mark by overlapping the index mark on the photographed image of the display screen of the display unit.

2. The imaging apparatus of claim 1, wherein the display controller determines a size of the index mark according to an aspect ratio of the display screen of the display unit.

3. The imaging apparatus of claim 1, further comprising:
a memory, which stores the angle information by corresponding the angle information with the photographed image in a frame unit; and
an image converter, which converts an image area provided by the index mark in the photographed image to a horizontal standard image by rotating the image area by the angle, according to the image of the subject and corresponding angle information read from the memory.

4. An imaging method for displaying a photographed image of a subject formed on an imaging surface of an image pickup device on a display screen of a display unit, the imaging method comprising:
detecting angle information about an angle of the imaging surface of the image pickup device tilted with respect to a horizontal standard that is perpendicular to a gravity direction, based on a reference point on a plane having a photographing direction of the subject as a normal, in a holding location of a body of an imaging apparatus during photographing;
generating an index mark by rotating the photographed image by the angle based on the reference point according to the angle information; and
displaying the index mark by overlapping the index mark on the photographed image of the display screen of the display unit.

5. The imaging method of claim 4, further comprising determining a size of the index mark according to an aspect ratio of the display screen of the display unit.

6. The imaging method of claim 4, further comprising:
storing the angle information by corresponding the angle information with the photographed image in a frame unit; and
converting an image area provided by the index mark in the photographed image to a horizontal standard image by rotating the image area by the angle, according to the image of the subject and corresponding angle information read from the memory.

7. A computer program product, comprising a computer usable medium having a computer readable program code embodied therein, said computer readable program code adapted to be executed to implement an imaging method in a computer, the imaging method comprising:
detecting angle information about an angle of an imaging surface of an image pickup device tilted with respect to a horizontal standard that is perpendicular to a gravity direction, based on a reference point on a plane having a photographing direction of a subject as a normal, in a holding location of a body of an imaging apparatus during photographing;
generating an index mark by rotating a photographed image of the subject by the angle based on the reference point according to the angle information, and displaying the index mark by overlapping the index mark on the photographed image of a display screen of a display unit;
storing the angle information by corresponding the angle information with the photographed image in a frame unit; and
converting an image area provided by the index mark in the photographed image to a horizontal standard image by rotating the image area by the angle, according to the image of the subject and corresponding angle information read from the memory.

8. The program of claim 7, wherein a size of the index mark is determined according to an aspect ratio of the display screen of the display unit.
